(19) United States
(12) Patent Application Publication
(10) Pub. No.: US 2008/0155026 A1
(43) Pub. Date: Jun. 26, 2008

(54) System and Method for Sharing Continuous Email Activity with Recipients Using Continuity Service

(76) Inventors: Fonda J. Daniels-Farrar, Cary, NC (US); Ruthie D. Lyle, Durham, NC (US); Angela Richards Jones, Durham, NC (US); Michael Muller, Medford, MA (US)

Correspondence Address: IBM CORPORATION - RSW (JVL);C/O VAN LEEUWEN & VAN LEEUWEN, P.O. BOX 90609, AUSTIN, TX, 78709-0609, US

(21) Appl. No.: 11/614,178

(22) Filed: Dec. 21, 2006

(51) Int. Cl. G06F 15/16

(52) U.S. Cl. 709/206

(57) ABSTRACT

A system, method, and program product that receives an email message at a first computer system, the received email message being subsequent to an original email message that was addressed to a group of email recipients, and the received email message is addressed to one of the email participants that include the email recipients and the original sender of the original email message. The system, method, and computer program product identifies whether a continuity of service was set for the original email message. If the continuity of service was set for the original email message and that the received email message is addressed to the original sender, then the received email message is forwarded to the other email recipients.

### BACKGROUND OF THE INVENTION

1. Technical Field

The present invention relates to a system and method that provides continuity of a series of email messages with multiple participants. More particularly, the present invention relates to a system and method that provides return receipt notification for multiple participants.

2. Description of the Related Art

Electronic mail (email) is one of the most popular forms of communication, especially in organizational settings. An advantage of email is that, although it is a fast form of communication, it is an asynchronous form of communication where participants can read and respond to email messages at a convenient time without having to schedule a particular meeting time, which is often needed for telephone and other forms of communication. Another advantage of email communications is that it is relatively simple to send a single email message to multiple recipients. While emailing to multiple participants is advantageous, it also faces particular challenges.

One challenge of using email to communicate with multiple participants is that errors can occur that are not easily communicated to all participants. For example, if the sender incorrectly entered one of the email addresses or if one of the recipients did not receive the email message for any of a number of technical reasons (e.g., mailbox full, etc.), the original sender of the email message is informed of the problem with a “bounce back” service message. However, in traditional email systems, these service messages are only sent back to the sender and are not propagated to the other recipients. When this occurs, the recipients may assume that all listed recipients received the same message, even though some of the recipients did not receive the message. This misperception is a problem when two or more of the recipients have dependent tasks that assume the information in the email has been relayed to all of them. In traditional systems, the original sender needs to forward the service message to the other recipients so that they know that one of the recipients did not receive the email message. Even with this knowledge, recipients would need to manually remove the erroneous email address from the recipient list when replying to all, else they will receive another notification that the address is unreachable.

Another common type of service message is a “return receipt” message. When a “return receipt” is requested, each recipient is asked to indicate that they reviewed the email message. However, like other service messages described above, in traditional systems these return receipts are only sent back to the original sender and are not propagated back to the other participants. If one of the recipients is on vacation, out of the office, or just hasn't opened the email, the original sender will not get a return receipt from that recipient. However, the other participants will be unaware that one of the participants has not read the email message unless the original sender forwards the return receipts to the other participants or otherwise communicates which participants have returned receipts.

### SUMMARY

It has been discovered that the aforementioned challenges are resolved using a system, method and computer program product that receives an email message at a first computer system, the received email message being subsequent to an original email message that was addressed to a group of email recipients, and the received email message is addressed to one of the email participants that include the email recipients and the original sender of the original email message. The system, method, and computer program product identifies whether a continuity of service was set for the original email message. If the continuity of service was set for the original email message and the received email message is addressed to the original sender, then the received email message is forwarded to the other email recipients.

In one embodiment, the system, method and computer program product identifies a copy of the original email message on a nonvolatile storage device accessible to the computer system and modifies the copy of the original email message to include a record of the received email message.

In another embodiment, the system, method and computer program product identifies that the received email message is a return receipt message from a return receipt sender, the return receipt sending being one of the email recipients. The return receipt message includes a timestamp corresponding to a reception of the original email message and an identity of the return receipt sender. A copy of the original email message is identified on a nonvolatile storage device accessible to the computer system, and the copy of the original email message is modified to include a record of the received email message, with the record including the timestamp and the identity of the return receipt sender. In a further embodiment, an email listing is displayed to a user of the computer system, with the email listing including an entry corresponding to the modified copy of the original email message. When the user requests the return receipt data corresponding to the original email message, the timestamp and the identity of the return receipt sender are displayed to the user.

In an additional embodiment, when the continuity of service was set for the original email message and the received email message is not addressed to the original sender, then the system, method and computer program product determines whether a copy of the original email message is stored on a nonvolatile storage device assessable to the computer system. If the copy of the original email message is stored on the nonvolatile storage device, then the copy of the original email message is modified to include a record of the received email message. Otherwise, the received email message is simply stored on the nonvolatile storage device.

In one embodiment, prior to the receiving, the continuity of service is set by the original sender of the original email message. The original sender then sends the original email message to the email recipients over the computer network. The original email message is received at another computer system used by one of the email recipients. The recipient's computer system then sends the email message back to the original sender's computer system. The email message is either an error message or a return receipt acknowledgement message.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a high-level diagram showing components used in providing email continuity service;

FIG. 2 is a flowchart showing the steps taken by an email server in handling “bounce back” messages;

FIG. 3 is a flowchart showing the steps taken by an email server in handling return receipt requests;

FIG. 4 is a flowchart showing the steps taken to add return receipts to email messages;

FIG. 5 is a flowchart showing the steps taken by an email client when receiving email from the email server;

FIG. 6A shows screen diagrams that depict the display of return receipt information on the original sender's email system;

FIG. 6B shows screen diagrams that depict the display of return receipt information on the receiver's email system;

FIG. 7 is a flowchart showing the steps taken by an originator when receiving a bounce back error message concerning one of the recipients in the original message; and

FIG. 8 is a block diagram of a data processing system in which the methods described herein can be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

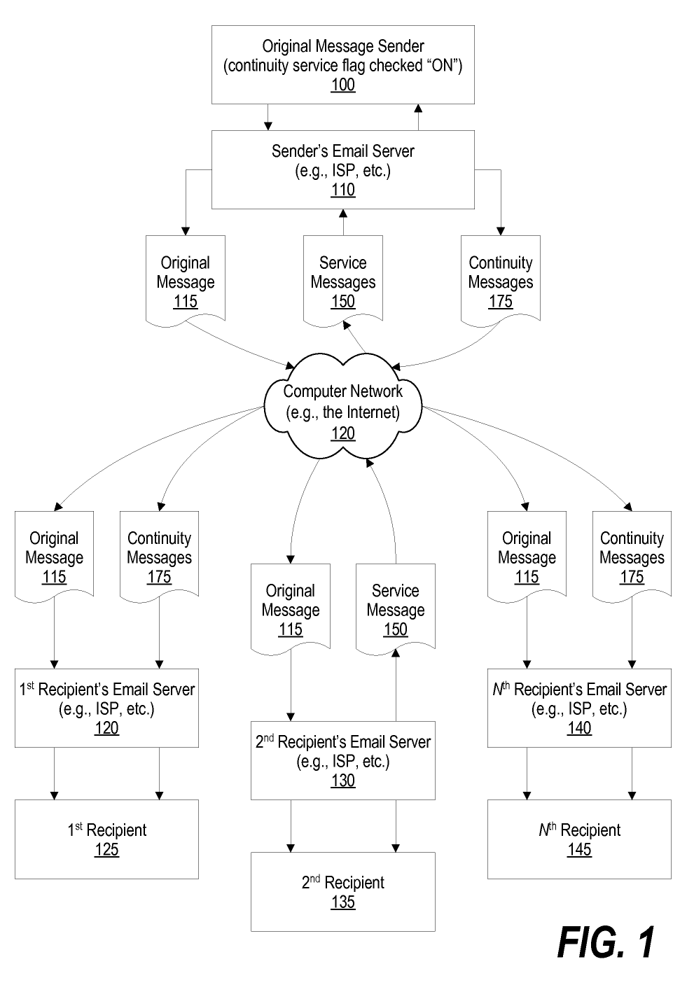

FIG. 1 is a high-level diagram showing components used in providing email continuity service. In this diagram, original sender 100 uses email server 110 to send and receive email messages. Message sender 100 composes original message 115 and sets a continuity service flag to indicate that continuity service is being requested for the original message. Email server 110 sends original message 115 to recipients (125, 135, 145) using computer network 120, such as the Internet, a Local Area Network (LAN), a Wide Area Network (WAN), or a Public Switched Telephone Network (PSTN).

Original message 115 is received by the various recipients' email servers (email server 120, 130, and 140, respectively). In the example, one of the email servers replies with service message 150 which is returned to original sender 100 via computer network 120 and the sender's email server 110. Service message 150 can be any one of a number of types of service messages including, but not limited to, an error “bounce back” message (such as the email address being incorrect for the domain served by the server, the recipients' email storage being full, as well as an “auto-reply” message indicating that the recipient is out of the office or otherwise not receiving email message), and “return receipt” message that are returned from recipients when they have opened the original message.

In one embodiment, the sender's email server receives service message 150, determines that the continuity service flag was set for the original message, and sends continuity service messages 175 back to the original recipients and also sends the continuity service message back to the sender of the service message (in the example shown, the service message was received from second recipient 135, so the continuity service message is not sent back to this recipient). Now, if there was a problem in sending the message to recipient 135, this information will be known by the other recipients when they receive continuity service message 175. Likewise, if the service message was a return receipt indicating that second recipient 135 had opened the original message, this information would also be propagated back to the other recipients so that they would know that second recipient 135 had opened the original message. In an alternate embodiment, the sender's computer system handles the sending of continuity service messages by receiving service message 150 from email server 110, recognizing that a continuity service flag was set for the original message, and sending continuity service message 175 back to the recipients (excluding the recipient that sent the service message).

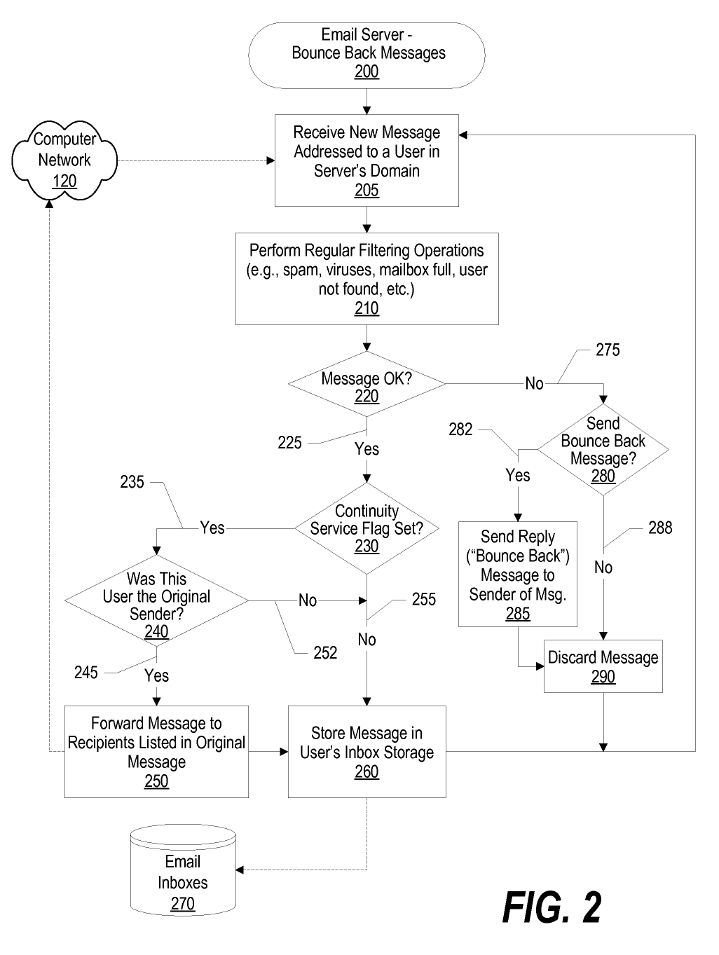

FIG. 2 is a flowchart showing the steps taken by an email server in handling “bounce back” service messages. Processing commences at 200 whereupon, at step 205, the email server receives a new email message addressed to a user in the server's domain (e.g., ibm.com, yahoo.com, etc.). At step 210, the server performs regular filtering operations, such as checking if the received message is a spam message, if the received message includes a virus, if the user to whom the email is addressed is out of storage space (storage full), or if the email is incorrectly addressed (i.e., the email account to whom the email is addressed does not exist). Based on the filtering performed in step 210, a determination is made as to whether the message is acceptable for delivery (decision 220). If the message is acceptable for delivery, then decision 220 branches to “yes” branch 225 whereupon another determination is made as to whether the continuity service flag was set for the original message (decision 230). If the continuity service flag was set for the original message, then decision 230 branches to “yes” branch 235 whereupon a determination is made as to whether the user being served by the email server was the sender of the original email message (decision 240). If the user was the sender of the original email message, then decision 240 branches to “yes” branch 245 whereupon, at step 250, the received message is forwarded to the recipients listed in the original email message except that the message is not forwarded to the recipient from whom this new message was received. At step 260, the new email message is stored in the user's inbox storage of email message (email inboxes 270). On the other hand, returning to decision 240, if the user to whom this message is addressed was not the sender of the original email message, then decision 240 branches to “no” branch 252, bypassing step 250, and the message is stored at step 260. Forwarding the messages when the user is the sender of the original email message prevents duplicate service messages being received by the recipients. Now, returning to decision 230, if the continuity service flag was not set, then decision 230 branches to “no” branch 255 bypassing steps 240 through 250 and the message is simply stored at step 260. After the message has been handled and stored, processing loops back to receive and process the next new message.

Returning to decision 220, if the filtering operations performed at step 210 reveal a problem with the incoming email message or with the user's account, then decision 220 branches to “no” branch 275 for further processing. A determination is made as to whether a bounce back message should be sent (decision 280). Depending on the type of problem encountered will determine whether a bounce back message is returned. For example, if the new message is a spam message it is likely that a bounce back message is not sent because it would only add unnecessary network traffic. However, if the problem is that the user's account space is full or that the email address is incorrect, then a bounce back message is typically sent in order to inform the sender of the problem so it can be rectified. If a bounce back message should be sent, then decision 280 branches to “yes” branch 282 whereupon, at step 285, a bounce back message is sent to the sender of the received email message informing the sender of the problem and the message is discarded at step 290. On the other hand, if a bounce back message is not being sent, then decision 280 branches to “no” branch 288 bypassing step 285 and the message is discarded at step 290. After the message has been handled, processing loops back to receive and process the next new message.

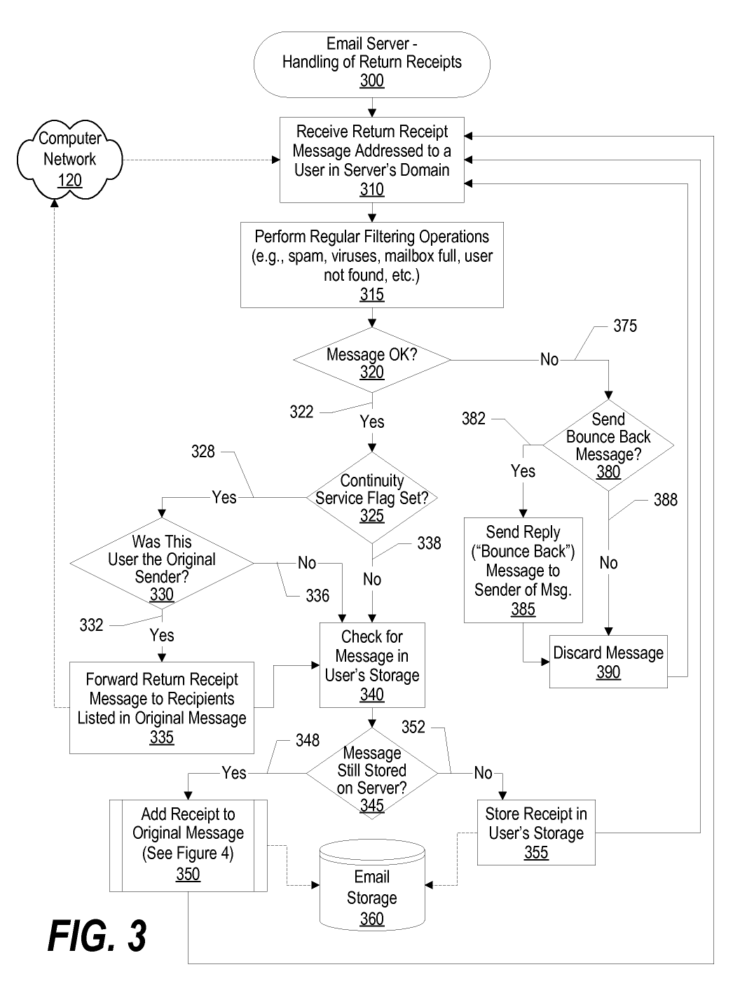

FIG. 3 is a flowchart showing the steps taken by an email server in handling return receipt requests. Processing commences at 300 whereupon, at step 310, the email server receives a return receipt message that is addressed to an email account served by the email server (i.e., in the server's domain). At step 310, the server performs regular filtering operations, such as checking if the received return receipt message is a spam message, if the received message includes a virus, if the user to whom the email is addressed is out of storage space (storage full), or if the email is incorrectly addressed (i.e., the email account to whom the email is addressed does not exist). Based on the filtering performed in step 310, a determination is made as to whether the return receipt message is acceptable for delivery (decision 320). If the return receipt message is acceptable for delivery, then decision 320 branches to “yes” branch 325 whereupon another determination is made as to whether the continuity service flag was set for the original message (decision 325). If the continuity service flag was set for the original message, then decision 325 branches to “yes” branch 328 whereupon a determination is made as to whether the user being served by the email server was the sender of the original email message (decision 330). If the user was the sender of the original email message, then decision 330 branches to “yes” branch 332 whereupon, at step 335, the received return receipt message is forwarded to the recipients listed in the original email message except that the message is not forwarded to the recipient that is the sender of this return receipt message.

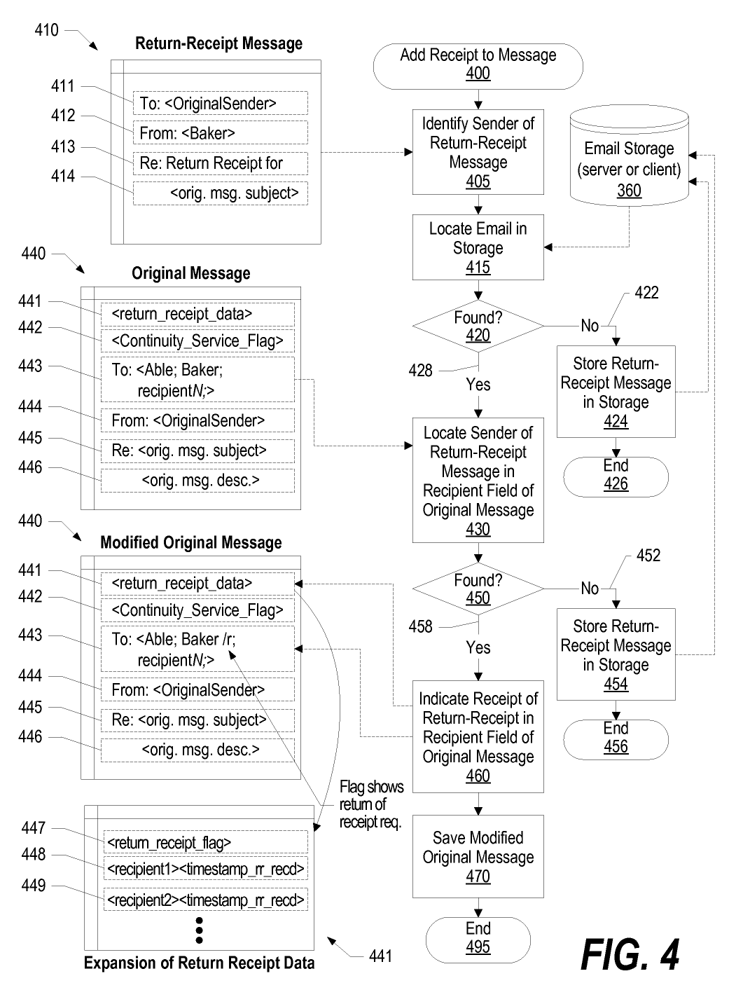

At step 340, a check is made for the original message that corresponds to this return receipt message. A determination is made as to whether the original message is still stored on a nonvolatile storage device (360) accessible to the email server (decision 345). If the original message is still stored on a nonvolatile storage device accessible to the email server, then decision 345 branches to “yes” branch 348 whereupon, at predefined process 350, the return receipt is added to the original message text (see FIG. 4 and corresponding text for processing details). On the other hand, if the original message is no longer stored on a nonvolatile storage device accessible to the email server, then decision 345 branches to “no” branch 352 whereupon, at step 355, the return receipt is stored in user's storage email storage 360. Returning to decision 330, if this user is not the sender of the original email that requested continuity service, then decision 330 branches to “no” branch 336 bypassing step 335 and processing continues with step 340 and either adds the return receipt to the original message or stores the return receipt in user's email storage 360. Returning to decision 325, if continuity service was not requested for the original email message, then decision 325 branches to “no” branch 338 bypassing forwarding of the return receipt message (bypassing steps 330 and 335). Instead, processing continues at step 340 with the return receipt either being added to the original message or stored in the user's email storage. After the return receipt message has been handled and stored, processing loops back to receive and process the next new message.

Returning to decision 320, if the filtering operations performed at step 310 reveal a problem with the incoming return receipt message or with the user's account, then decision 320 branches to “no” branch 375 for further processing. A determination is made as to whether a bounce back message should be sent (decision 380). Depending on the type of problem encountered will determine whether a bounce back message is returned. For example, if the new message is a spam message it is likely that a bounce back message is not sent because it would only add unnecessary network traffic. However, if the problem is that the user's account space is full or that the email address is incorrect, then a bounce back message is typically sent in order to inform the sender of the problem so it can be rectified. If a bounce back message should be send, then decision 380 branches to “yes” branch 382 whereupon, at step 385, a bounce back message is sent to the sender of the received email message informing the sender of the problem and the message is discarded at step 390. On the other hand, if a bounce back message is not being sent, then decision 380 branches to “no” branch 388 bypassing step 385 and the message is discarded at step 390. After the return receipt message has been handled, processing loops back to receive and process the next new message.

FIG. 4 is a flowchart showing the steps taken to add return receipts to email messages. This processing is called in order to add return receipt data to an original message. Processing commences at 400 whereupon, at step 405, the identity of the sender of return receipt message 410 is determined. Return receipt message 400 includes various pieces of data. This includes addressee data 411 that identifies the intended recipient of the return receipt message (e.g., the original sender or one of the other recipients when the return receipt is forwarded from the original sender to the other recipients). Return receipt message 410 also includes sender identity 412 that identifies the sender of the return receipt message. Sender identity 412 is the piece of data analyzed in step 405. In addition, return receipt message includes subject 413 that identifies this message as a return receipt message and body 414 which identifies the original message. Return receipt message also includes a timestamp that indicates when the return receipt message was sent.

At step 415, an attempt is made to locate the original email in user's email storage 360. A determination is made as to whether the original email message was located (decision 420). If the original email was not found, then decision 420 branches to “no” branch 422 whereupon, at step 424, the return receipt message is stored in user email storage 360. On the other hand, if the original email message was found, then decision 420 branches to “yes” branch 428 whereupon, at step 430, the sender of the return receipt message is located in a recipient field of original email message 440. Original message 440 includes a number of fields including return receipt data field 441, continuity service flag field 442, addressee field 443, from address field 444, subject field 445, and original message body field 446. The sender of the return receipt message is matched against the addresses in addressee field 443. A determination is made as to whether the sender of the return receipt message was found in the addresses in addressee field 443 (decision 450). If the sender is not found, then decision 450 branches to “no” branch 452 whereupon, at step 454, the return receipt message is stored in user's email storage 360 and processing ends at 456. On the other hand, if the sender is found in addressee field 443, then decision 450 branches to “yes” branch 458 whereupon, at step 460, original email message 440 is modified to indicate the reception of a return receipt from one of the recipients. In one embodiment, return receipt data 441 is modified. In a further embodiment, a flag is included with the addressee names to indicate which of the recipients have provided return receipts. Expansion of return receipt data field 441 shows that the return receipt data includes return receipt flag field 447 that requested a return receipt for the original email message. The return receipt data field also includes return receipt data fields, such as fields 448 and 449. These return receipt data fields include the recipients that have returned return receipts and the timestamps that show when the return receipts were returned. At step 470, the modified original email message is saved with the updated return receipt data. Processing to add return receipt data to the original message then ends at 495.

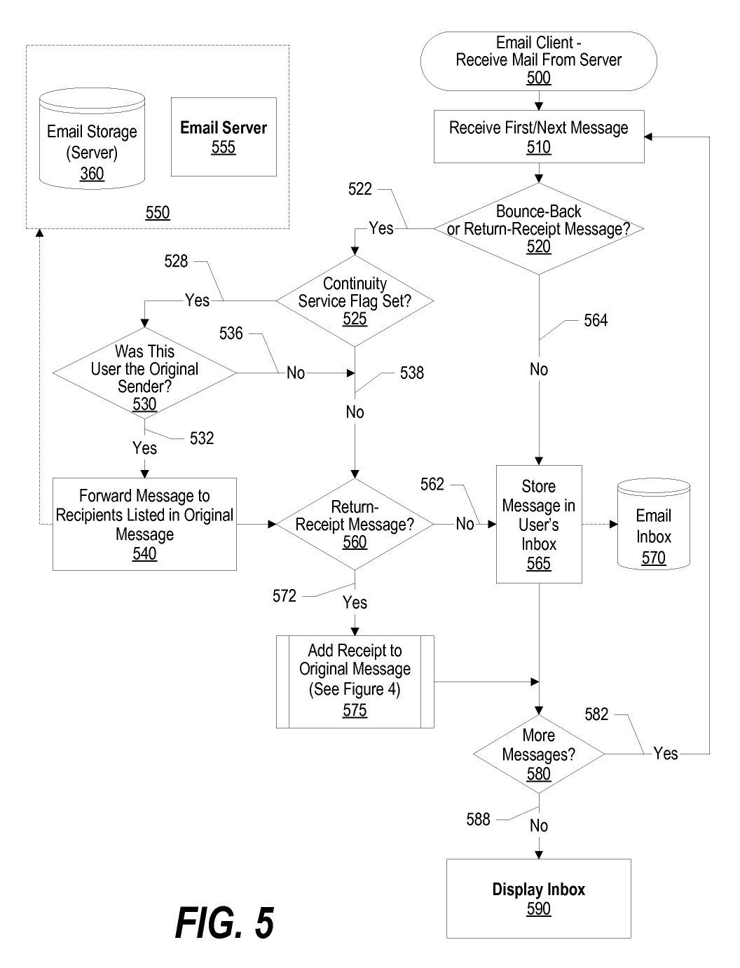

FIG. 5 is a flowchart showing the steps taken by an email client when receiving email from the email server. This processing can be performed if the user's email server does not provide continuity service or can be performed if the user downloaded the original message from the email server to local nonvolatile storage that is inaccessible to the email server. Processing commences at 500 whereupon at step 510, the message is received. A determination is made as to whether the received message is a service message (decision 520). A service message includes including bounce back messages and return receipt messages. If the message is a service message, then decision 520 branches to “yes” branch 522 whereupon another determination is made as to whether the continuity service flag was set on the original message (decision 525). If the continuity service flag was set on the original message, then decision 525 branches to “yes” branch 528 whereupon a determination is made as to whether this user was the sender of the original email message (decision 530). If this user was the sender of the original email message, then decision 530 branches to “yes” branch 532 whereupon, at step 540, the email message is forwarded to the recipients listed in the original email message, except that the message is not forwarded to the sender of the message that was received at step 510. If this user was not the sender of the original email message, then decision 530 branches to “no” branch 536 bypassing step 540. Likewise, if the continuity service was not set for the original email message, then decision 525 branches to “no” branch 538 also bypassing step 540.

A determination is made as to whether the message received at step 510 is a return receipt message (decision 560). If the message is not a return receipt message, then decision 560 branches to “no” branch 562 whereupon, at step 565, the message is stored in user's inbox 570. User's inbox 570 is stored in a nonvolatile storage area accessible to the user's computing device. On the other hand, if the message that was received at step 510 is a return receipt message, then decision 560 branches to “yes” branch 572 whereupon, at predefined process 575, the return receipt data is added to the original message (see FIG. 4 and corresponding text for processing details). Returning to decision 520, if the message is not a service message (i.e., a return receipt message or a bounce back message), then decision 520 branches to “no” branch 564 and, at step 565, the message is simply stored in user's inbox 570.

After the received message has been processed, a determination is made as to whether there are more messages (decision 580). If there are more message, decision 580 branches to “yes” branch 582 which loops back to receive and process the next message. This looping continues until all message have been received and processed, at which time decision 580 branches to “no” branch 588 and the user's updated inbox is displayed at step 590.

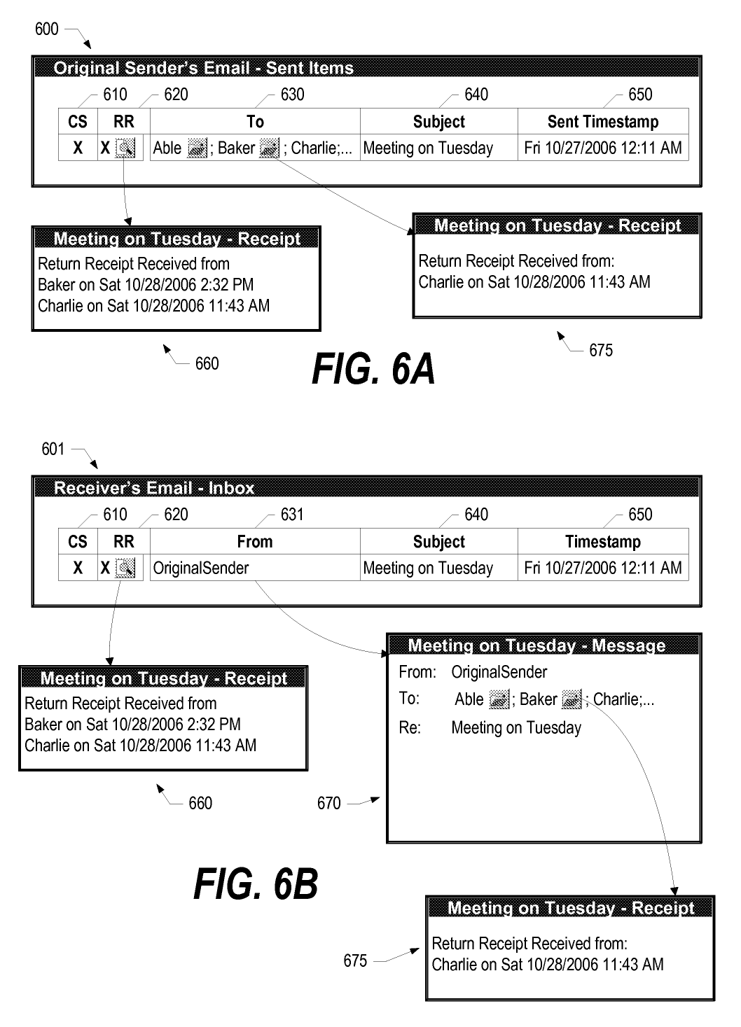

FIG. 6A shows screen diagrams that depict the display of return receipt information on the original sender's email system. The original sender's sent items display is depicted as window 600. This window includes a listing of items sent by the sender with various fields shown in the window. These fields include continuity service field 610, return receipt field 620, “sent to” field 630, subject field 640, and sent timestamp field 650. Icons are displayed next to the return receipt flag (that indicates that the message that was sent was sent with return receipts requested). When the user selects the icon in the return receipts field, return receipts window 660 is displayed. Return receipts window 660 summarizes the recipients that have returned receipts for the message that was sent. The summary provided in return receipts window 660 also includes the timestamp corresponding to when each of the recipients returned the receipt. Alternatively, or in addition, to the return receipts selection, icons can be displayed next to each of the recipients that returned a receipt. When one of these icons is selected by the user, window 675 is displayed showing details about the particular recipient and when the recipient returned the receipt.

FIG. 6B shows screen diagrams that depict the display of return receipt information on the receiver's email system. Window 601 shows an inbox for one of the recipients and is quite similar in format and detail to window 600 shown in FIG. 6A. Window 601 includes a listing of items received by the recipient with various fields shown in the window. These fields include continuity service field 610, return receipt field 620, “from” field 631, subject field 640, and timestamp field 650. Icons are displayed next to the return receipt flag (that indicates that the message that was sent was sent with return receipts requested). When the user selects the icon in the return receipts field, return receipts window 660 is displayed. Return receipts window 660 summarizes the recipients that have returned receipts for the message that was sent. The summary provided in return receipts window 660 also includes the timestamp corresponding to when each of the recipients returned the receipt. When the user selects an entry in the inbox, window 670 is displayed with the contents of the message. In the example shown, window 670 shows the original message that is requesting a meeting for a particular day. An icon is displayed next to each of the recipients that returned a receipt. When one of these icons is selected by the user, window 675 is displayed showing details about the particular recipient and when the recipient returned the receipt.

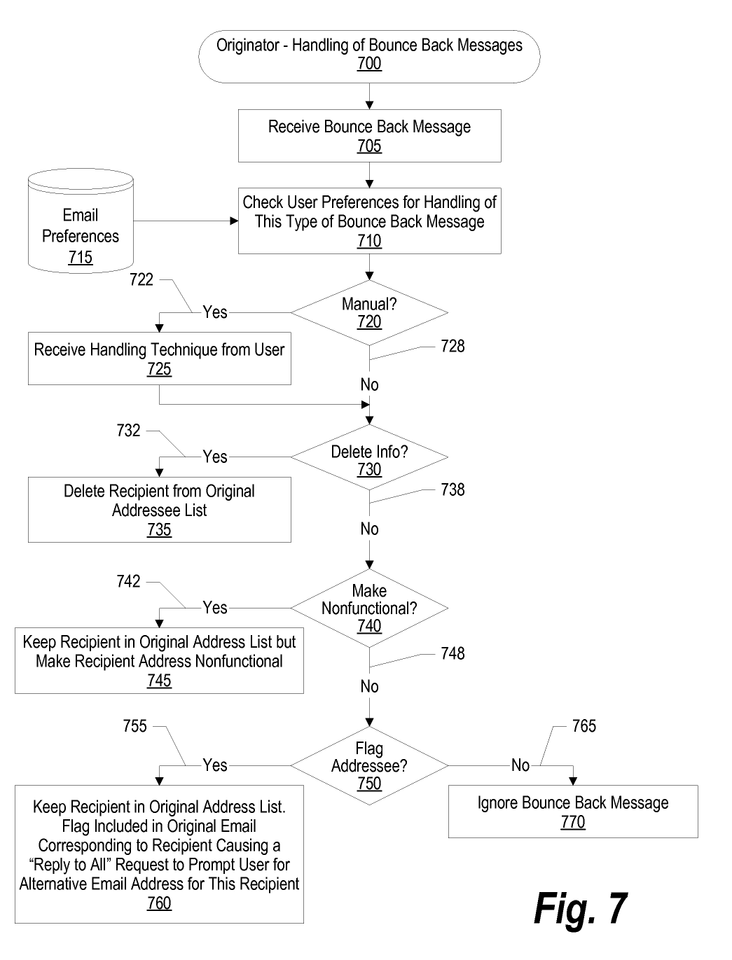

FIG. 7 is a flowchart showing the steps taken by an originator when receiving a bounce back error message concerning one of the recipients in the original message. Processing commences at 700 whereupon, at step 705, the originator receives a bounce back message corresponding to an email message that was sent to a group of participants. The originator's computer system receives the message from the originator's email server.

At step 710, the originator's email program checks the originator's user preferences (email preferences 715) to determine how the user would like to handle this bounce back message. There are different types of bounce back messages depending on the situation that caused the bounce back message to be sent by the recipient's email server. Examples of bounce back messages include a message that the email address is invalid, a message that the recipient has exceeded his or her email storage so the email could not be delivered, and a bounce back indicating that the user is out of the office or otherwise not checking email for some period of time. Depending on the type of bounce back message that was received, a different handling technique may be used. Based on the user preferences and the type of bounce back message, the user may prefer to manually select a handling technique (decision 720). If the user's preference is to manually select a handling technique, then decision 720 branches to “yes” branch 722 whereupon, at step 725, the handling technique to use for the recipient is received from the user. On the other hand, if the user's preference is to have a handling technique automatically selected based on the type of bounce back message and the user's preferences, then the handling technique is retrieved in step 710 and decision 720 bypasses step 725.

A determination is made as to whether the handling technique for the recipient that corresponds to the bounce back message is to delete the recipient from the original email message (decision 730). If the handing technique is to delete the recipient's address from the original message, then decision 730 branches to “yes” branch 732 whereupon, at step 735, the recipient's email address is removed from the original email message. In one embodiment, the revised original message is sent back to the other recipients so that they have an original message with the correct list of recipients. In another embodiment, a message is sent to the other recipients informing the recipients' email programs to either automatically or manually delete the recipient from the list of addressees in the original email message. On the other hand, if the handling technique is not to delete the recipient's information from the original message, then decision 730 branches to “no” branch 738 bypassing step 735.

A determination is made as to whether the handling technique for the recipient that corresponds to the bounce back message is to keep the recipient's email address in the address list of the original email but make the address nonfunctional (decision 740). In other words, when a user does a “reply to all” on the original message, the recipient's address would appear in the reply message but the reply message would not be sent to the recipient as it is a nonfunctional address. If this is the selected handling technique, then decision 740 branches to “yes” branch 742 whereupon, at step 745, the recipient's email address is made nonfunctional in the original email message. In one embodiment, the revised original message is sent back to the other recipients so that they have an original message with the correct list of recipients. In another embodiment, a message is sent to the other recipients informing the recipients' email programs to either automatically or manually make the recipient's address nonfunctional in the list of addressees in the original email message. On the other hand, if the handling technique is not to make the recipient's address nonfunctional, then decision 740 branches to “no” branch 748 bypassing step 745.

A determination is made as to whether the handling technique for the recipient that corresponds to the bounce back message is to keep the recipient's email address in the address list of the original email and flag the recipient's email address as being potentially problematic (decision 750). When a user does a “reply to all” on the original message, the user will be given an opportunity to provide an alternative email address for the recipient. If this is the selected handling technique, then decision 750 branches to “yes” branch 755 whereupon, at step 760, the recipient's email address is flagged in the original email message. In one embodiment, the revised original message is sent back to the other recipients so that they have an original message with the flagged recipient. In another embodiment, a message is sent to the other recipients informing the recipients' email programs to either automatically or manually flag the recipient's address in the list of addressees in the original email message. On the other hand, if the handling technique is not to flag the recipient's email address in the original message, then decision 750 branches to “no” branch 765 whereupon, at step 770, the originator ignores the bounce back message.

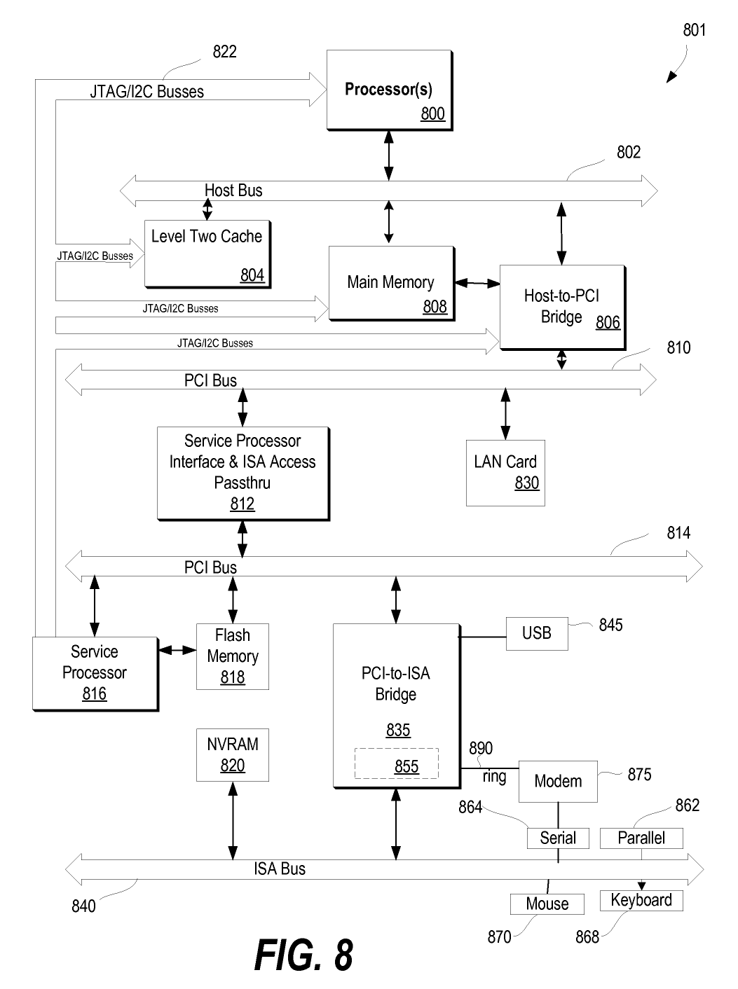

FIG. 8 illustrates information handling system 801 which is a simplified example of a computer system capable of performing the computing operations described herein. Computer system 801 includes processor 800 which is coupled to host bus 802. A level two (L2) cache memory 804 is also coupled to host bus 802. Host-to-PCI bridge 806 is coupled to main memory 808, includes cache memory and main memory control functions, and provides bus control to handle transfers among PCI bus 810, processor 800, L2 cache 804, main memory 808, and host bus 802. Main memory 808 is coupled to Host-to-PCI bridge 806 as well as host bus 802. Devices used solely by host processor(s) 800, such as LAN card 830, are coupled to PCI bus 810. Service Processor Interface and ISA Access Pass-through 812 provides an interface between PCI bus 810 and PCI bus 814. In this manner, PCI bus 814 is insulated from PCI bus 810. Devices, such as flash memory 818, are coupled to PCI bus 814. In one implementation, flash memory 818 includes BIOS code that incorporates the necessary processor executable code for a variety of low-level system functions and system boot functions.

PCI bus 814 provides an interface for a variety of devices that are shared by host processor(s) 800 and Service Processor 816 including, for example, flash memory 818. PCI-to-ISA bridge 835 provides bus control to handle transfers between PCI bus 814 and ISA bus 840, universal serial bus (USB) functionality 845, power management functionality 855, and can include other functional elements not shown, such as a real-time clock (RTC), DMA control, interrupt support, and system management bus support. Nonvolatile RAM 820 is attached to ISA Bus 840. Service Processor 816 includes JTAG and 12C busses 822 for communication with processor(s) 800 during initialization steps. JTAG/I2C busses 822 are also coupled to L2 cache 804, Host-to-PCI bridge 806, and main memory 808 providing a communications path between the processor, the Service Processor, the L2 cache, the Host-to-PCI bridge, and the main memory. Service Processor 816 also has access to system power resources for powering down information handling device 801.

Peripheral devices and input/output (I/O) devices can be attached to various interfaces (e.g., parallel interface 862, serial interface 864, keyboard interface 868, and mouse interface 870 coupled to ISA bus 840. Alternatively, many I/O devices can be accommodated by a super I/O controller (not shown) attached to ISA bus 840.

In order to attach computer system 801 to another computer system to copy files over a network, LAN card 830 is coupled to PCI bus 810. Similarly, to connect computer system 801 to an ISP to connect to the Internet using a telephone line connection, modem 875 is connected to serial port 864 and PCI-to-ISA Bridge 835.

While FIG. 8 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving at a first computer system an email message, wherein the received email message is subsequent to an original email message that was addressed to a plurality of email recipients, wherein the receiving is performed over a computer network, and wherein the received email message is addressed to one of a plurality of email participants that includes the plurality of email recipients and an original sender of the original email message;
identifying whether a continuity of service was set for the original email message; and
in response to identifying that the continuity of service was set for the original email message and that the received email message is addressed to the original sender:
forwarding the received email message to the plurality of email recipients.

2. The method of claim 1 further comprising:
identifying a copy of the original email message on a nonvolatile storage device accessible to the first computer system; and
modifying the copy of the original email message to include a record of the received email message.

3. The method of claim 1 further comprising:
identifying that the received email message is a return receipt message from a return receipt sender, the return receipt sending being one of the plurality of email recipients, and the return receipt message including a timestamp corresponding to a reception of the original email message and an identity of the return receipt sender;
identifying a copy of the original email message on a nonvolatile storage device accessible to the first computer system; and
modifying the copy of the original email message to include a record of the received email message, the record including the timestamp and the identity of the return receipt sender.

4. The method of claim 3 further comprising:
displaying an email listing to a user of the first computer system, wherein the email listing includes an entry corresponding to the modified copy of the original email message;
receiving, from the user, a selection requesting return receipt data corresponding to the original email message; and
displaying the timestamp and the identity of the return receipt sender in response to receiving the selection requesting return receipt data.

5. The method of claim 1 further comprising:
determining that the received email message is a bounce back message from a selected one of the plurality of email recipients; and
removing the selected email recipient from a list of the recipients included in a copy of the original message stored on a nonvolatile storage device that is accessible to the first computer system.

6. The method of claim 1 further comprising:
in response to identifying that the continuity of service was set for the original email message and that the received email message is not addressed to the original sender:
determining whether a copy of the original email message is stored on a nonvolatile storage device assessable to the first computer system;
in response to determining that the copy of the original email message is stored on the nonvolatile storage device, modifying the copy of the original email message to include a record of the received email message; and
in response to determining that the copy of the original email message is not stored on the nonvolatile storage device, storing the received email message on the nonvolatile storage device.

7. The method of claim 1 further comprising:
prior to the receiving:
setting the continuity of service by the original sender of the original email message;
sending the original email message to the plurality of email recipients over the computer network;
receiving the original email message at a second computer system used by one of the plurality of email recipients; and
sending the email message from the second computer system to the first computer system, wherein the email message is selected from the group consisting of an error message and a return receipt message.

8. A information handling system comprising:
one or more processors;
a memory accessible by at least one of the processors;
a nonvolatile storage area accessible by at least one of the processors;
a network interface adapter that connects the information handling system to a computer network; and
a set of instructions stored in the memory, wherein one or more of the processors executes the set of instructions in order to perform actions of:
receiving at the information handling system via the network interface adapter an email message, wherein the received email message is subsequent to an original email message that was addressed to a plurality of email recipients, wherein the receiving is performed over the computer network, and wherein the received email message is addressed to one of a plurality of email participants that includes the plurality of email recipients and an original sender of the original email message;
identifying whether a continuity of service was set for the original email message; and
in response to identifying that the continuity of service was set for the original email message and that the received email message is addressed to the original sender:
forwarding the received email message to the plurality of email recipients by transmitting the received email message to the email recipients over the computer network.

9. The information handling system of claim 8 wherein the instructions perform further actions comprising:
identifying a copy of the original email message on the nonvolatile storage area; and
modifying the copy of the original email message to include a record of the received email message.

10. The information handling system of claim 8 wherein the instructions perform further actions comprising:
identifying that the received email message is a return receipt message from a return receipt sender, the return receipt sending being one of the plurality of email recipients, and the return receipt message including a timestamp corresponding to a reception of the original email message and an identity of the return receipt sender;
identifying a copy of the original email message on the nonvolatile storage area; and
modifying the copy of the original email message to include a record of the received email message, the record including the timestamp and the identity of the return receipt sender.

11. The information handling system of claim 10 further comprising:
a display device accessible by at least one of the processors, wherein the instructions perform further actions comprising:
displaying, on the display device, an email listing to a user of the information handling system, wherein the email listing includes an entry corresponding to the modified copy of the original email message;
receiving, from the user, a selection requesting return receipt data corresponding to the original email message; and
displaying, on the display device, the timestamp and the identity of the return receipt sender in response to receiving the selection requesting return receipt data.

12. The information handling system of claim 8 wherein the instructions perform further actions comprising:
determining that the received email message is a bounce back message from a selected one of the plurality of email recipients; and
removing the selected email recipient from a list of the recipients included in a copy of the original message stored on a nonvolatile storage device that is accessible to the first computer system.

13. The information handling system of claim 8 wherein the instructions perform further actions comprising:
in response to identifying that the continuity of service was set for the original email message and that the received email message is not addressed to the original sender:
determining whether a copy of the original email message is stored in the nonvolatile storage area;
in response to determining that the copy of the original email message is stored in the nonvolatile storage area, modifying the copy of the original email message to include a record of the received email message; and
in response to determining that the copy of the original email message is not stored in the nonvolatile storage area, storing the received email message on the nonvolatile storage area.

14. A computer program product stored in a computer readable medium, comprising functional descriptive material that, when executed by a data processing system, causes the data processing system to perform actions that include:
receiving at a first computer system an email message, wherein the received email message is subsequent to an original email message that was addressed to a plurality of email recipients, wherein the receiving is performed over a computer network, and wherein the received email message is addressed to one of a plurality of email participants that includes the plurality of email recipients and an original sender of the original email message;
identifying whether a continuity of service was set for the original email message; and
in response to identifying that the continuity of service was set for the original email message and that the received email message is addressed to the original sender:
forwarding the received email message to the plurality of email recipients.

15. The computer program product of claim 14 wherein the functional descriptive material, when executed by the data processing system, cause the data processing system to perform further actions that comprise:
identifying a copy of the original email message on a nonvolatile storage device accessible to the first computer system; and
modifying the copy of the original email message to include a record of the received email message.

16. The computer program product of claim 14 wherein the functional descriptive material, when executed by the data processing system, cause the data processing system to perform further actions that comprise:
identifying that the received email message is a return receipt message from a return receipt sender, the return receipt sending being one of the plurality of email recipients, and the return receipt message including a timestamp corresponding to a reception of the original email message and an identity of the return receipt sender;
identifying a copy of the original email message on a nonvolatile storage device accessible to the first computer system; and
modifying the copy of the original email message to include a record of the received email message, the record including the timestamp and the identity of the return receipt sender.

17. The computer program product of claim 16 wherein the functional descriptive material, when executed by the data processing system, cause the data processing system to perform further actions that comprise:
displaying an email listing to a user of the first computer system, wherein the email listing includes an entry corresponding to the modified copy of the original email message;
receiving, from the user, a selection requesting return receipt data corresponding to the original email message; and
displaying the timestamp and the identity of the return receipt sender in response to receiving the selection requesting return receipt data.

18. The computer program product of claim 14 wherein the functional descriptive material, when executed by the data processing system, cause the data processing system to perform further actions that comprise:
determining that the received email message is a bounce back message from a selected one of the plurality of email recipients; and
removing the selected email recipient from a list of the recipients included in a copy of the original message stored on a nonvolatile storage device that is accessible to the first computer system.

19. The computer program product of claim 14 wherein the functional descriptive material, when executed by the data processing system, cause the data processing system to perform further actions that comprise:
in response to identifying that the continuity of service was set for the original email message and that the received email message is not addressed to the original sender:
determining whether a copy of the original email message is stored on a nonvolatile storage device assessable to the first computer system;
in response to determining that the copy of the original email message is stored on the nonvolatile storage device, modifying the copy of the original email message to include a record of the received email message; and
in response to determining that the copy of the original email message is not stored on the nonvolatile storage device, storing the received email message on the nonvolatile storage device in response to the determination.

20. The computer program product of claim 14 wherein the functional descriptive material, when executed by the data processing system, cause the data processing system to perform further actions that comprise:
prior to the receiving:
setting the continuity of service by the original sender of the original email message;
sending the original email message to the plurality of email recipients over the computer network;
receiving the original email message at a second computer system used by one of the plurality of email recipients; and
sending the email message from the second computer system to the first computer system, wherein the email message is selected from the group consisting of an error message and a return receipt message.
